(19) United States
(12) Patent Application Publication
(10) Pub. No.: US 2003/0185984 A1
(43) Pub. Date: Oct. 2, 2003

(54) Apparatus and method for creating faux finishes on a paintable surface

(76) Inventors: Thomas Kevin Niedenfuer, Merrifield, MN (US); Jean Marie Winbauer, Merrifield, MN (US)

Correspondence Address: MERCHANT & GOULD PC, P.O. BOX 2903, MINNEAPOLIS, MN, 55402-0903, US

(21) Appl. No.: 10/103,168

(22) Filed: Mar. 20, 2002

(51) Int. Cl. B05C 17/10; B05D 5/00

(52) U.S. Cl. 427/256; 15/244.4; 427/281; 427/280

(57) ABSTRACT

A method and apparatus for creating a faux finish on a paintable surface. The apparatus includes a polyvinyl alcohol block having first and second ends, and a longitudinal body extending between the first and second ends. The body also includes at least one planar painting surface and a beveled surface located adjacent the first end of the body.

The method includes the steps of applying paint to a work surface, contacting a polyvinyl alcohol painting apparatus against the work surface, manipulating the paint on the work surface with the polyvinyl alcohol block, and creating a decorative painting effect.

### FIELD OF THE INVENTION

This invention generally relates to an apparatus and method for applying color media to a paintable surface, and in particular to creating multiple decorative painted effects to walls.

### BACKGROUND OF THE INVENTION

Faux finish is a particular form of decorative painting that creates the appearance of an artistic effect or appearance on a painted surface. Typically, a person employing skilled and artistic decorative techniques creates faux finishes. These techniques are used to replicate many natural surfaces, such as rock, marble, or stucco. Creation of faux finishes is desirable because use of the natural materials that are being simulated by the faux finish is costly and can be difficult to manufacture or install with natural materials. For example, it is usually not cost-effective to use natural materials on an irregularly shaped surface. Utilizing a faux finish overcomes these problems and also permits utilizing non-traditional colors that coordinate with other interior elements.

Traditional faux finish techniques require a variety of specialized materials, such as paints, solvents, coloring agents, brushes, and sponges. Traditional processes are time consuming and generally require a high degree of skill to create a variety of faux finishes. Also, the typical equipment can be difficult to work with, and its use time consuming. Set-up for using traditional faux finish equipment and techniques is also time consuming because generally the edge and surrounding areas must be covered with a masking material to keep paint from being applied to the masked areas. Therefore improvements are desirable.

### SUMMARY OF THE INVENTION

One example embodiment of the present invention is directed to an apparatus for creating a faux finish on a surface. The apparatus includes a polyvinyl alcohol block. The polyvinyl block includes a first end, a second end and a longitudinal body extending between the first and second ends. The body includes at least one planar painting surface. The apparatus further includes a beveled surface located adjacent the first end of the body.

Another aspect of the present invention is directed to a method for creating a faux finish on a surface. The method includes a step of providing a polyvinyl alcohol block having a first end, a second end, a longitudinal body extending between the first and second ends, the body including at least one planar painting surface, and the block further including a first beveled surface located adjacent the first end of the body. The method further includes the steps of applying paint to the surface with a paint applicator, and creating a desired faux finish effect by manipulating the painting surface against the surface.

Another aspect of the present invention is directed to a method for painting. The method includes the steps of applying a paint to a work surface, contacting a polyvinyl alcohol painting surface against the work surface, manipulating the paint on the work surface with the polyvinyl alcohol block, and creating a decorative painting effect.

The above summary of the present invention is not intended to describe each disclosed embodiment or every implementation of the present invention. The Figures and the detailed description that follow more particularly exemplify these embodiments, to which the invention is not so limited.

### BRIEF DESCRIPTION OF THE DRAWINGS

The invention may be more completely understood in consideration of the following detailed description of various embodiments of the invention in connection with the accompanying drawings, in which:

FIG. 1 is a perspective view of an example embodiment of a painting apparatus.

FIG. 2A is perspective view of a paint applicator from the front side.

FIG. 2B is perspective view of the paint applicator of FIG. 2A from the reverse side.

FIG. 3 is perspective view of colors being applied to a paintable surface using the paint applicator of FIGS. 2A and 2B.

FIG. 4 is a perspective view of the painting apparatus of FIG. 1 being manipulated to create a faux finish.

FIG. 5 is a perspective view of the painting apparatus of FIG. 1 being used to paint a wall without masking an adjacent ceiling.

FIG. 6 is a perspective view of the painting apparatus of FIG. 1 being used to paint a wall without masking an object adjacent to the painted area.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION OF THE PREFERRED EMBODIMENT

The present disclosure is applicable to painting. In particular, the present disclosure is directed to a method and apparatus for creating faux finishes on painted surfaces. While the present invention is not so limited, an appreciation of various aspects of the invention will be gained through a discussion of the examples provided below.

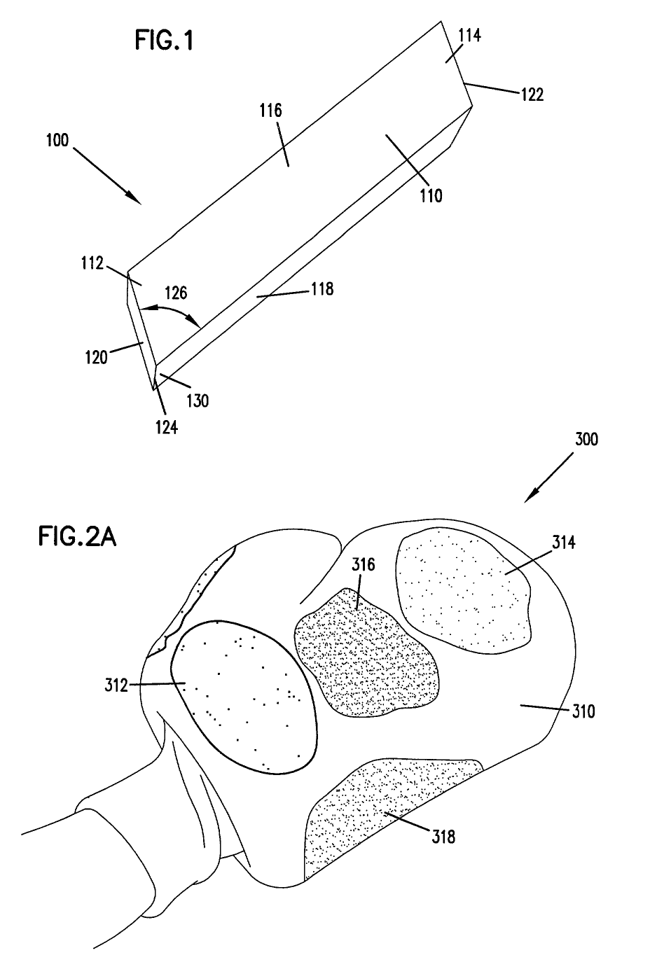

Referring to FIG. 1, shown is an example embodiment of a painting apparatus 100 of the present invention. Painting apparatus 100 is a polyvinyl alcohol block 110 including first and second ends 112, 114. A longitudinal body 116 extends between first and second ends 112, 114. The body 116 includes at least one planar painting surface 118. The block 110 further includes a first beveled surface 120 located at the first end 112 and a second beveled surface 122 located at the second end 114. While the example embodiment shown includes two beveled surfaces, only one beveled surface is required. The painting apparatus 100 also includes a detailing edge 124 formed by the intersection of the planar painting surface 118 and the first beveled surfaced 120.

The block is made from polyvinyl alcohol (PVA), which unexpectedly has been found to have excellent release and retention characteristics that make the material particularly useful for faux finish painting. PVA is available in stock form from a variety of manufacturers, including Harvard International. The stock form is generally in the shape of an elongated block, and the beveled surfaces 120, 122 of the present invention can be made by cutting or sawing the stock form into the desired shape of the present invention. In the example embodiment shown, the block has a square cross-sectional shape. Other cross-sectional shapes can be used, for example a triangle or rectangle, depending on the conditions and surroundings of the surface to be painted.

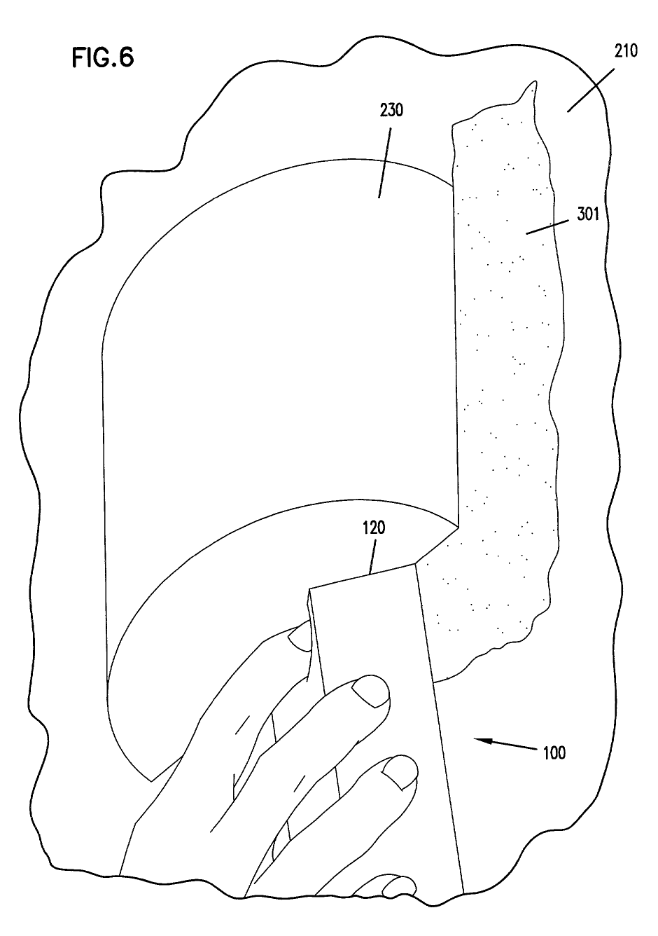

Referring to FIGS. 5 and 6, the beveled surface 120 allows the painting surface 118 to be used to create a faux finish on a paintable surface 210 to be painted without the use of masking materials because the beveled surface 120 allows the beveled edge 120 of the painting surface 118 to come into proximity to an edge 220 of the paintable surface 210 without contacting any surrounding surface 240 or object 230. Eliminating or reducing the need for masking saves time in the faux finish painting process.

The bevel angle 126 is preferably between 15 and 60 degrees, but one of skill in the art will recognize that the bevel angle can be varied to accommodate the surrounding areas 240 and objects 230 while eliminating or reducing the need for masking. In one preferred embodiment, the beveled surface 120 is oriented at a bevel angle 126 of about 25 degrees with respect to the planar painting surface 118.

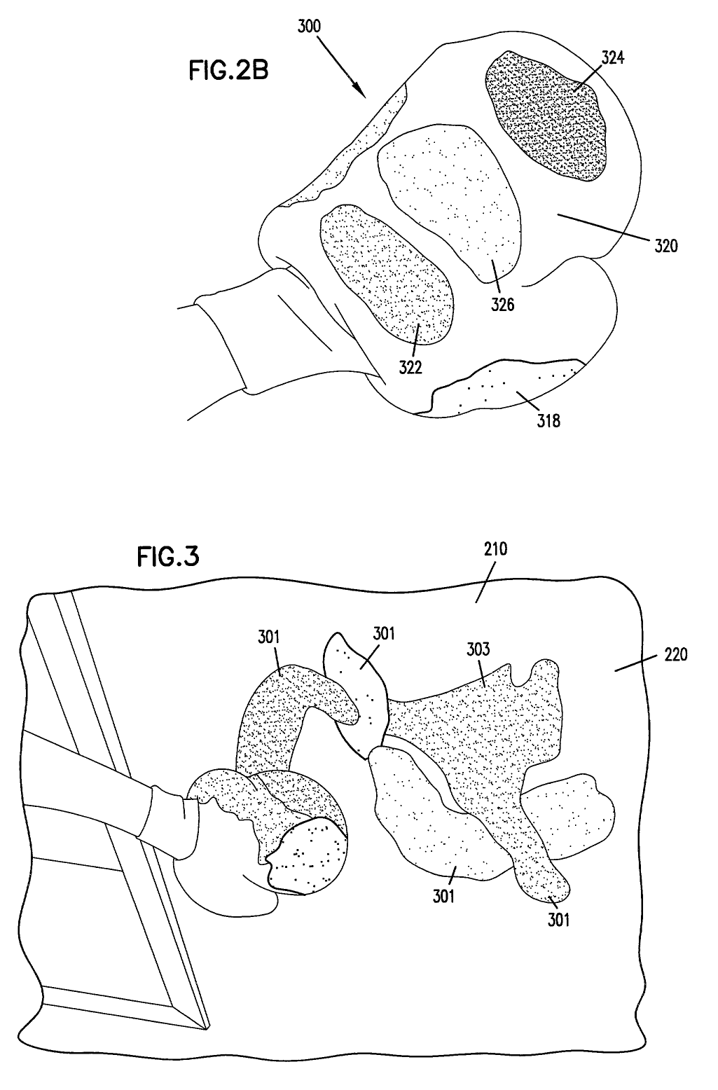

The painting apparatus 100 can be used to create a variety of faux finishes 200. Before the faux finish 200 is created, one or more colors of paint 301 are applied to the surface 210 or wall to be painted. If only a single color is to be applied, any convenient method of application can be used, including using a paint applicator such as a brush or a sponge. If it is desired to apply multiple colors, for example, to be blended or textured together, the preferred paint applicator is a mitt 300, FIGS. 2A and 2B. When using the mitt 300 to apply multiple colors, the desired colors of paint are poured onto different areas of the mitt 300. For example, up to eight different colors can be blended using different areas of the mitt 300; the heel 312 of the hand, finger tip area 314, middle 316, and side 318 on the palm side 310 of the mitt 300, and the heel of the hand 322, finger tip area 324, middle 326, and side 328 on the reverse side 320 of the mitt 300. The colors of paint are dabbed from the mitt 300 onto the wall 310 in an approximate 12-inch by 12-inch area.

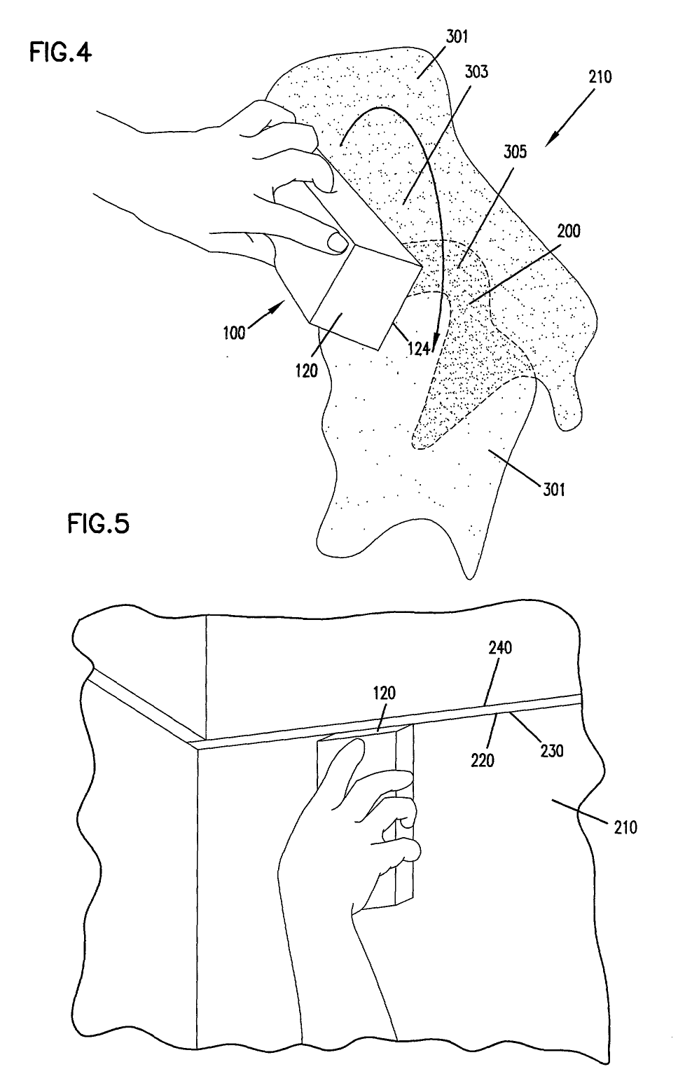

Referring to FIG. 4, to create a desired faux 200 finish effect, the painting apparatus 100 is lightly pressed in the middle 305 of the dabbed area 303 and then moved in a large, circular motion (similar to polishing the surface), until the colors of paint are blended and spread out to cover an area of approximately 2-foot by 2-foot, leaving the edge of the area feathered. One advantage of this method is that each area covered with paint can be done in a very short time. The preceding steps are repeated in another area until the entire surface to be painted is covered. An advantage of using the painting apparatus of the present invention is that creating a faux finish 200 on an 8-foot by 10-foot wall requires approximately 0.5 cups of paint.

Using the above described apparatus and method, a variety of faux finishes can be created. Soaking the painting apparatus 100 in water so that it retains water while being used to create faux effects also can enhance the effects described below. The present disclosure can be used with a variety of paints, including aqueous and latex based paints. When using a latex paint, the present disclosure is specially effective in blending multiple colors into a thin consistent layer on flat surfaces.

Examples of some of the faux finishes that can be accomplished using only the painting apparatus 100 and the paint applicator are hereinafter described. Various types of decorative painting for flat walls can be accomplished. To create a one layer, single color blended finish about 3 or 4 spots of one color of paint from the paint applicator are dabbed on the wall. The painting apparatus is wicked and blending starts in the middle of the paint spots that are then blended softly outward to feathered edges.

To create a suede finish, the same procedure as one layer, single color blend is carried out. However, a base background paint of a medium tone, natural color is applied to the surface. A finish color that is one shade lighter than the base color is used, and is blended sufficiently to allow a portion of the base color to show through. A leather finish can be created using the same technique as the suede finish, except the finish color used is one shade darker than the base color.

To create a one layer, multiple color blend, about 1 or 2 spots of each color of paint from the paint applicator (from 2 to 10 colors) are dabbed on the wall. The painting apparatus is wicked and blending begins in the middle of the paint spots, that are then blended softly outward to feathered edges. To create a two layer, single color blend, that adds more dimension and depth, the same technique as the one layer, single color blend is used, and in addition, when the first layer is dried, a second layer of a different color is added.

To create a stone finish, the same procedure as one layer, single color blend is used, except the background finish is white or cream color. To enhance the stone finish, about 3 neutral or natural colors are used for the finish. To create a marble finish, the same procedure as the stone finish is used. After the stone finish dries, the detailing edge of the beveled surface of the painting apparatus is dipped in one of the colors on the painting applicator, that is then used to create veining in the marble. Less pressure on the detailing edge produces a thinner line, and more pressure on the detailing edge widens the veining line. The painting apparatus is then used to softly blend the veins.

Endless varieties of other faux finishes can be accomplished using the present disclosure. For example, one of skill in the art will recognize that using a combination of the above techniques allows one to create aging and darkening finishes, a sky and clouds finish, a two layer metallic finish, and a multiple layer finish.

An advantage of the present disclosure is that adjustment layers can be easily applied. Since paint coloration is difficult for most people to do with accuracy and precision, the painting apparatus makes application of an adjustment layer easy because of the ability of painting apparatus to produce an almost transparent layer, thereby making color adjustment easier by the addition of a second layer.

The painting apparatus can also be used for decorative painting for textured finishes. The painting apparatus enables the user to accomplish additive and subtractive techniques at the same time on textured surfaces. The detailing edge of the painting apparatus can be used to push paint into crevices at the same time the painting surface or beveled surface removes paint from the top of the texture to create the appearance of depth. Also, the painting surface of the painting apparatus can be used to apply paint to only the top of the textured surface without tracking paint into the crevices, which also adds depth.

A textured finish includes any paintable surface where a first part of the surface is raised, and a second part of the surfaces has crevices. Examples of textured finishes are wood or plastic that includes carvings or impressions, raised wood grain in wood, scrunched paper bags glued to the wall, wicker, plaster, sheet rock, mud or cement with impressions, frieses, paintable moldings, sculptured murals, stones and bricks.

Fresco and Venetian plaster finishes can also be created using the present disclosure. To create fresco and Venetian plaster effects, after plaster or sheetrock mud has dried it is re-wetted with the painting surface of a water saturated painting apparatus. Paint colors are then applied from a clean paint applicator to the wetted plaster or mud area.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

What is claimed is:

1. An apparatus for creating a faux finish on a surface comprising:
a polyvinyl alcohol block including:
a first end;
a second end;
a longitudinal body extending between the first and second ends;
the body including at least one planar painting surface; and
a first beveled surface located at the first end of the body.

2. The apparatus further including a second beveled surface located adjacent the second end of the body.

3. The apparatus of claim 1 wherein a cross-section of the longitudinal body is a square.

4. The apparatus of claim 1 wherein the beveled surface is angled 25 degrees with respect to the painting surface.

5. A method for creating a faux finish on a work surface using a polyvinyl alcohol painting apparatus having a first end, a second end, a longitudinal body extending between the first and second ends, the body including at least one planar painting surface and a first beveled surface located adjacent the first end of the body, the method comprising:
applying paint to the surface with a paint applicator; and
creating a desired faux finish effect by manipulating the planar painting surface against the work surface.

6. The method of claim 5 further including the step of immersing the polyvinyl alcohol block in water before said step of creating the desired effect.

7. The method of claim 5, wherein said step of creating a desired effect includes blending multiple colors of a latex paint on a flat working surface in a thin consistent layer.

8. The method of claim 5, wherein said step of applying paint includes applying an aqueous based paint.

9. The method of claim 5 wherein said step of creating a desired effect includes creating a marbled finish.

10. The method of claim 5 further including the step of creating a veining effect using a detailing edge of the painting apparatus.

11. The method of claim 5 wherein said step of creating a desired effect includes creating a blended effect.

12. A method for painting, the method comprising the steps of:
applying a paint to a work surface;
contacting a polyvinyl alcohol painting apparatus against the work surface;
manipulating the paint on the work surface with the painting apparatus; and
creating a decorative painting effect.

13. The method of claim 12, wherein said step of applying paint includes applying an aqueous based paint.

14. The method of claim 12 wherein said step of creating a decorative painting effect includes creating a marbled finish.

15. The method of claim 12 further including the stop of creating a veining effect using a detailing edge of painting apparatus.

16. The method of claim 12 wherein said step of creating a decorative painting effect includes creating a blended effect.
